(19) United States
(12) Patent Application Publication
(10) Pub. No.: US 2010/0212440 A1
(43) Pub. Date: Aug. 26, 2010

(54) INTEGRATED CONTROL FOR DOUBLE CLUTCH

(76) Inventor: Pascal Thery, Amiens (FR)

Correspondence Address: TROP, PRUNER & HU, P.C., 1616 S. VOSS ROAD, SUITE 750, HOUSTON, TX, 77057-2631, US

(21) Appl. No.: 12/160,700

(22) PCT Filed: Jan. 15, 2007
(86) PCT No.: PCT/FR07/00086

§ 371 Date: Jul. 11, 2008

(30) Foreign Application Priority Data
Jan. 18, 2006 (FR) 0600601

(51) Int. Cl. F16H 3/087

(52) U.S. Cl. 74/330

(57) ABSTRACT

Transmission including a dual clutch transferring the torque of an engine to two input primary shafts of a gearbox, each clutch including one disk connected in rotation to one of the primary shafts, that can be tightened between plates of which one is axially mobile thanks to a control mechanism, one of these control mechanisms including a piston guided by a cylindrical surface integrated into an axial housing of a primary shaft, characterised in that the guiding cylindrical surface is located as close as possible to the shaft's housing, this surface being directly made inside the shaft's housing or inside a body inserted into the housing which end is connected to the casing of the gearbox via a fastening shifted outside the housing.

This invention involves a transmission including a dual clutch, especially for automotive vehicles.

A known type of automatic gearbox with dual clutch includes two input primary shafts each connected to the shaft of an engine via a clutch that can operate dry or in oil, each primary shaft transfers the movement with various reduction ratios defining each a speed, to one or several secondary shafts of the gearbox themselves connected in rotation to the driving wheels. Each reduction ratio can be engaged by clutching a gear wheel on its shaft after synchronisation of the rotational speeds. These ratios, considered in the increasing order of the speed-increasing ratios, are alternatively distributed on a primary shaft and on the other.

Engaging a second ratio installed on the second primary shaft by closing the corresponding gear wheel, then by simultaneously closing the second clutch and opening the first clutch, does the shift from a first to a second ratio. The torque is gradually transferred from the first to the second ratio without breaking the transfer of the engine torque.

The continuity of the torque transfer allows smooth gearshifts that provide driving comfort and better performances, the acceleration being kept without break.

The clutch control mechanisms and the gear shifting devices include actuators controlled by a control unit that uses information concerning the engine and vehicle operation, and receiving driver requests.

The dual clutch gearbox can also include power transfers between the primary shafts, as shown in the document WO2006/125876.

Such a dual clutch is described in the document EP-A1-0185176 that shows an engine flywheel fixed to a crankshaft, including a central plate being a reaction plate for two friction disks arranged supported on either side, each disk being tightened on its other side by a pressure plate moving along the axis. Two actuators, each including a concentric annular hydraulic actuator, apply a load on each pressure plate via a bearing and an annular lever.

A main disadvantage of this dual clutch is that the control system includes two actuators arranged on the same side compared to the clutches, which makes it more complex, expensive, and comparatively big in the radial direction as well as in the axial one, whereas the dual clutch already has a higher axial size than the one of a single clutch.

In addition, the connection between a control actuator placed on the side of the gearbox and the pressure plate of the clutch placed on the side of the engine is complicated because it needs a connection crossing the other clutch to provide the transfer of the axial force. This enforces the use of connection parts that increase the complexity, the cost and the size. Moreover, these connection parts do bend during the transfer of a force, which adds some elasticity in the control mechanism and reduces the available stroke for the axial movement of the pressure plate.

To solve this issue, another kind of known clutch is described in the document EP-A3-1245863; it includes a hydraulic actuator axially aligned with the clutches and placed at the rear end of the gearbox on the opposite side to the engine, so to actuate the clutch located on engine side via a sliding rod in the primary shafts.

This actuator includes a pipe providing the guiding of a sliding piston to create a chamber receiving the hydraulic pressure. A pad of the gearbox's casing includes a bore in which the pipe fits, it includes a thick wall covering the major part of the pipe to maintain it in position. In order to limit the axial length of the gearbox, the pad including the pipe fits into a housing formed at the end of a primary shaft.

A disadvantage of this device is that its significant radial size forces to plan a bigger diameter for the end of the primary shaft including the pad, for the bearing supporting this end as well as for the supported gear wheels. The size, the weight and the cost are higher, the distance between the shafts can also be more significant.

This invention notably aims avoiding these disadvantages and offering a compact, easy, efficient and cost-effective solution for the realisation of a dual clutch control mechanism integrated to a shaft.

To that end, it offers a transmission including a dual clutch transferring the torque of an engine to two input primary shafts of a gearbox, each clutch including at least one friction disk connected in rotation to one of the primary shafts, that can be tightened between plates of which one is axially mobile thanks to a control mechanism, one of these control mechanisms including a piston guided by a cylindrical surface integrated into an axial housing of a primary shaft, characterised in that the guiding cylindrical surface is located as close as possible to the shaft's housing, this surface being directly made in the shaft's housing or in a body inserted into the housing which end is connected to the casing of the gearbox via a fastening shifted outside the housing.

As the guiding cylindrical surface of the integrated control mechanism does not include any fixturing system that would radially interfere between this surface and the housing, this housing has a reduced axial size which allows limiting the external diameter of the primary shaft containing it.

Usefully, as the guiding surface is realised in a body inserted into the housing, this body includes a cylindrical part for the sliding of the piston and a flared end forming a flange with a higher diameter than the cylindrical part for the fastening to the casing which is located outside the housing of the primary shaft.

For the fastening to the casing, the flange can include a plane radial side providing the perpendicularity, a cylindrical part providing the centring and a supporting flange for a leak-proof sealing.

According to a variant in which the piston circumscribes a chamber for the hydraulic pressure, a closing disk closing the pressure chamber can be fixed in a tight manner on the casing, this closing disk can be crimped on the casing.

Usefully, a leak-proof sealing between the casing and the primary shaft closes an additional chamber surrounding the body, this chamber being supplied in oil via a duct.

According to a variant in which the piston is pushed via a mechanical system, a sealing is planed between the piston and the body.

The mechanical pushing system can be a rod that pushes at the end of an axial hollow formed in the piston, this hollow axially covering a major part of the guiding surface of the piston.

Preferably, a hinged lever on the casing and transferring a force coming from an actuator, is supported by the mechanical system.

According to a variant, the body is executed via an impact extrusion process of an aluminium disc, this body can be fixed to the casing via crimping.

According to another variant, the body is executed via moulding of a plastic material, this body can be fixed to the casing via clamping.

In the case where the guiding surface is directly realised in the shaft's housing, the piston slides in a bore formed by this housing and circumscribes a chamber for the hydraulic pressure.

A dynamic leak-proof gasket can provide the sealing of the pressure chamber between the primary shaft and the casing, a supporting part can connect the dynamic leak-proof gasket and the casing.

The bore of the primary shaft can include a closing system for supporting a spring.

According to a realisation mode, the piston is moulded in plastic material.

According to an especially attractive combination, the clutch controlled by the piston does not include any internal device for the wear adjustment of the friction disks.

A better understanding of the invention and a clearer vision of some other characteristics and advantages will derive from the reading of the description hereafter, given as an example with reference to the attached drawings in which:

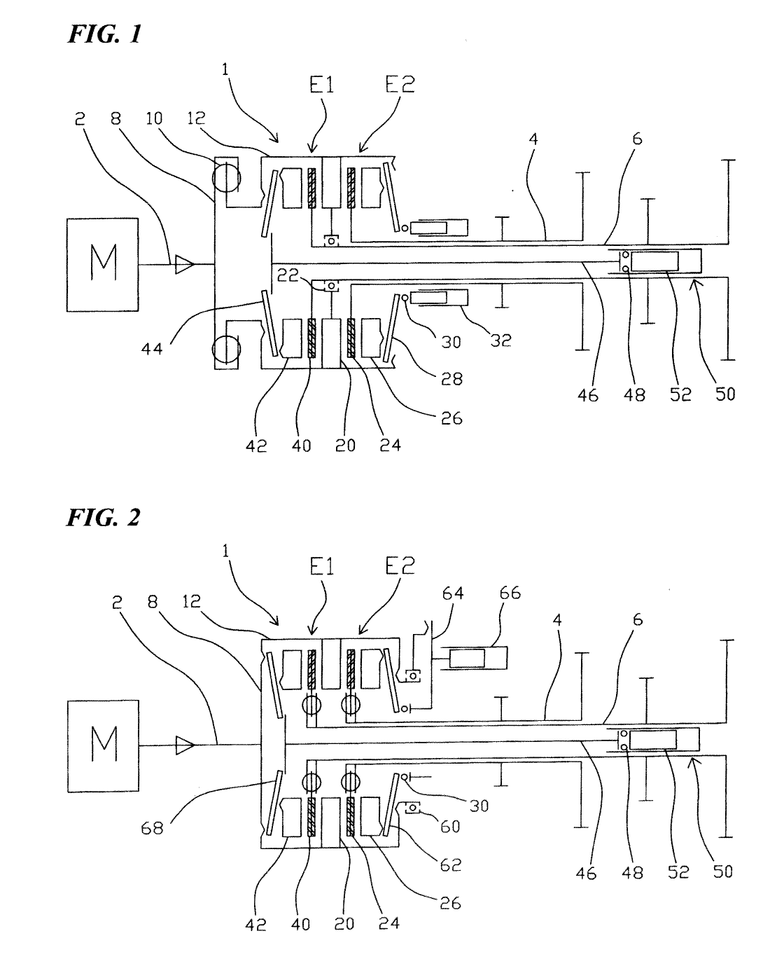

the FIG. 1 represents a partial schematic of a transmission according to the invention;

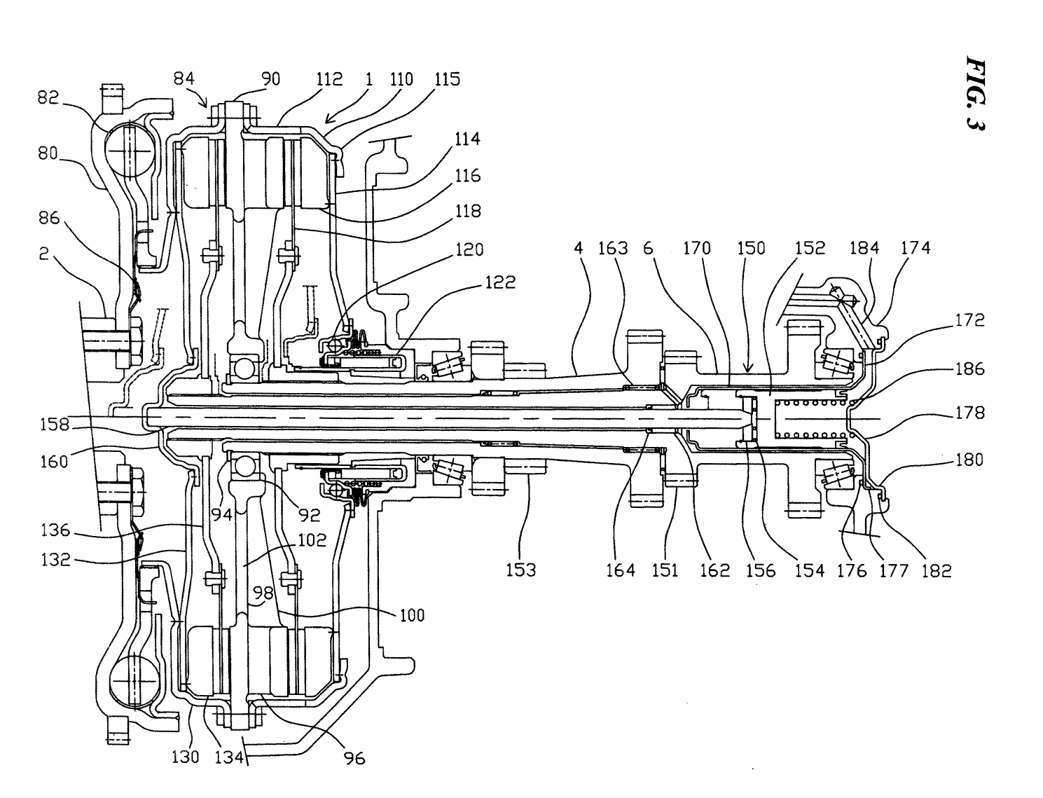

the FIG. 2 represents a partial schematic including a dual clutch according to a variant;

the FIG. 3 represents a detailed section view of a dual clutch with its control mechanisms;

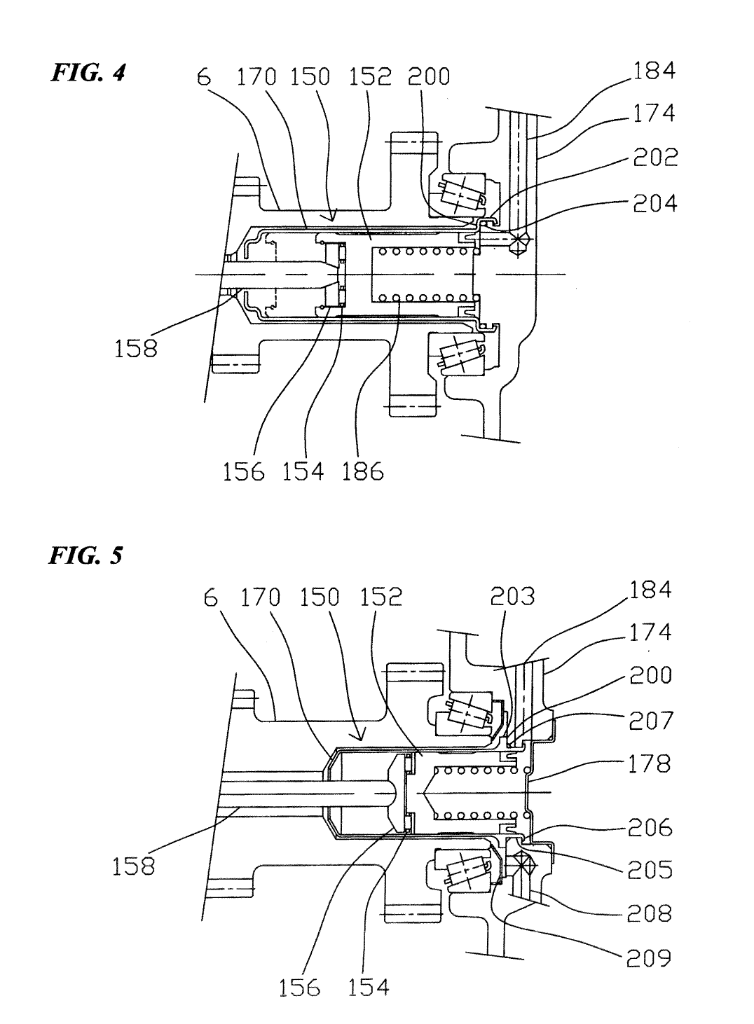

the FIG. 4 represents a detailed section view with a control mechanism according to a first variant;

the FIG. 5 represents a detailed section view with a control mechanism according to a second variant;

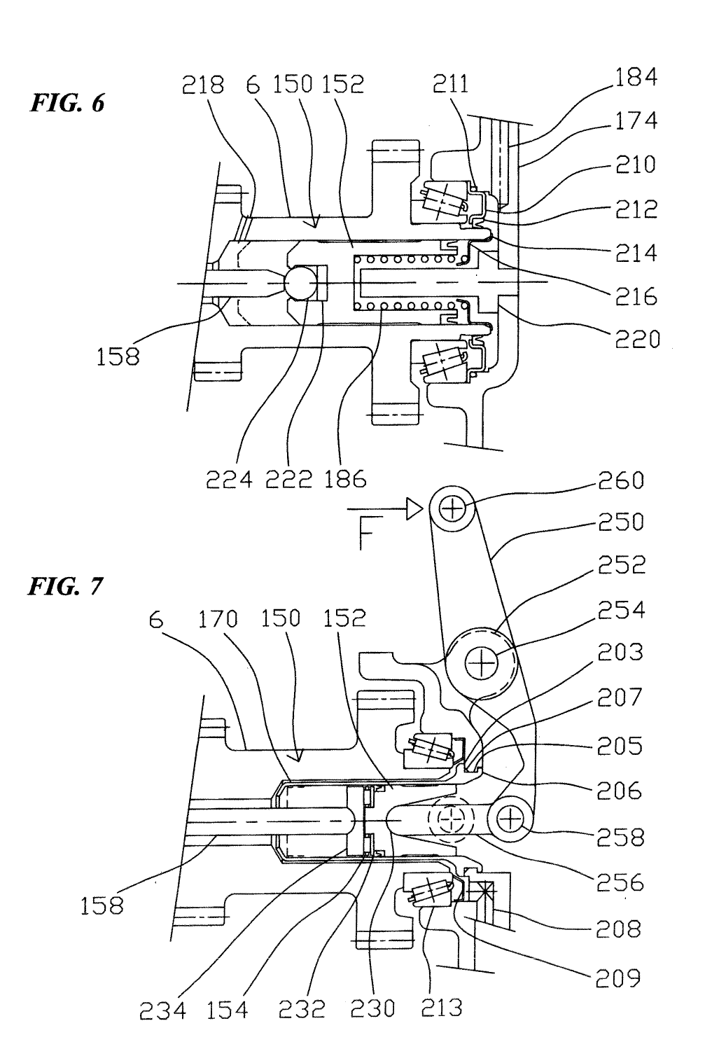

the FIG. 6 represents a detailed section view with a control mechanism according to a third variant;

the FIG. 7 represents a detailed section view with a control mechanism according to a fourth variant.

The FIG. 1 represents a transmission including a dual clutch 1 connecting the shaft 2 of an engine to the concentric input primary shafts 4, 6 of a gearbox, each shaft includes gear wheels that can provide various reduction ratios in order to drive the driving wheels of a vehicle. The external primary shaft 4 is hollow, it contains the internal primary shaft 6 that crosses it from end to end.

A primary engine flywheel 8 that can have an axial flexibility to damp the flexion oscillations of the engine shaft 2, is fixed at the end of this shaft; via springs 10 having a circumferential action, it drives a secondary flywheel 12 formed by the driving part of the dual clutch 1, in order to build-up a dual flywheel for the damping of torsional vibrations.

The secondary flywheel 12 includes a central plate 20 centred and axially maintained by a bearing 22 which is fixed on one end of the external primary shaft 4. This central plate 20 serves as a reaction plate for two friction disks 24, 40 arranged axially on either sides. At standstill, the two disks are not tightened, they form two open clutches.

A first disk 24 placed on the side of the gearbox is connected in rotation to the external primary shaft 4, this first clutch can be closed by the tightening of a pressure plate 26 connected in rotation to the secondary flywheel 12, and moved by a first control mechanism including an annular lever 28, a thrust bearing 30 and an annular hydraulic actuator 32 fixed on the casing of the gearbox. The progress of the piston of the actuator 32 towards the engine moves the lever 28 that, by being supported by the flywheel 12 on his external periphery, applies a tightening force on the plate 26 with a given force increasing ratio depending on the distance between the supporting points forming lever arms.

A second disk 40 placed on engine side is connected in rotation to the internal primary shaft 6, this second clutch can be closed by tightening a pressure plate 42 connected in rotation to the secondary flywheel 12 and moved by a second control mechanism. This second control mechanism includes an annular lever 44, a hydraulic actuator 50 placed according to the clutch axis and integrated inside the internal hollow primary shaft 6, and a piston 52 oriented towards the engine that actuates via a thrust bearing 48 a control rod 46 which other end is pushed on a central part of the annular lever 44. The secondary flywheel 12 supports this lever in a radially intermediate area in order to apply on its external periphery a tightening force on the plate 42 with a given force-increasing ratio depending on the length of the lever arms.

The FIG. 2 represents a variant of the transmission of FIG. 1, the engine shaft 2 is directly connected to the secondary flywheel 12 via a rigid connection that can have a radial flexibility. The friction disks 24, 40 include springs in the hub that have a circumferential action to perform the damping of the torsional vibrations.

The centring and the axial supporting of the secondary flywheel 12 is different, it includes a bearing 60 that connects the side of the flywheel 12 oriented towards the gearbox to the casing of this gearbox.

Both clutches are closed at standstill, the friction disks 24, 40 being tightened by the levers 62, 68 building springs of diaphragm type and applying, at standstill, an axial load on the pressure plates 26, 42.

The control mechanism of the first clutch differs from the one of FIG. 1, a hydraulic actuator 66 is mounted outside the casing of the gearbox, the force it applies to unclutch is transferred via a fork 64 that swivels, supported by the casing, then via the thrust bearing 30 to the diaphragm 62. The control mechanism of the second clutch remains similar, the hydraulic actuator 50 applies a force through the thrust bearing 48 and the control rod 46 on radial cams of the diaphragm 68 to open the clutch.

Generally speaking and within the scope of the invention, the variants of FIGS. 1 and 2 can be combined together to reach various operating or sizing characteristics.

The arrangement of the hydraulic actuator 50 of the second clutch inside the second primary shaft 6, with a non represented fastening shifted outside, has some advantages, especially it allows installing a single control mechanism 32, 64, between the dual clutch 1 and the gearbox, that has a reduced axial length compared to a dual control mechanism. In addition, the used devices, annular actuator 32 or fork 64, are similar to those of the gearboxes with manual control using a single actuator, which allows the use of standard technologies. The control mechanism of the second clutch including the actuator 50 adds almost no additional length to the gearbox insofar as it is integrated to the primary shaft 6. In addition, as it includes a full actuator without internal crossing, its realisation is easy and cost-effective and its frictions are reduced, which improves the accuracy and the efficiency. Moreover, the shaft diameter remains limited.

The FIG. 3 represents a dual clutch 1 realised according to the schematic of FIG. 1. A primary flywheel 80 fixed at the end of a crankshaft 2 of a thermal engine drives, via long springs 82 arranged circumferentially, a secondary flywheel 84 including the dual clutch. A braking device 86 allows together with the springs 82 to damping the oscillations between the two flywheels and to filtering the vibrations.

The movement coming from the springs 82 is transferred via a cover 130 to a central plate 90 that is supported and axially maintained by a ball bearing 92 fixed at an end of the first primary shaft 4, and maintained in position by an open ring 94 placed in a slot of the shaft. The central plate 90 has a radially external part that is thicker and that includes two circular transversal friction sides for the friction disks 118, 136. In an axially median part between these sides, we find a series of radial channels 96 evenly spaced on the circumference and open at their ends, performing with the rotation an internal forced air ventilation that cools the central plate 90, which, beside this, receives heat energy on its friction sides.

The central plate 90 includes a connection part with a more or less flat disk shape 98 connecting the bearing 92 to the part of the plate receiving the friction side that is oriented towards the engine. Some ribs 100, parallel to the rotation axis, connect the bearing support 92 to the thicker part of the central plate 90, they are located between two radial channels 96 to free the air way, they contribute to the air flow in the channels 96 via a driving into rotation of the air. In addition, openings 102 are made between the ribs 100 in the connecting disk 98 to lighten it.

The direct fastening of the central plate 90 on a primary shaft of the gearbox via the bearing 92 as well as the ribs 100 provide a precise positioning and a significant axial stiffness to the part including the friction sides that receives axial loads coming from the control mechanisms. This allows reducing the lifting losses on the pressure plates 116, 134 due to the elastic bending, and thus reducing the strokes of the actuators and increasing the control accuracy of the clutch. In addition, the clutches' control mechanisms do not transfer axial forces to the engine shaft 2, as these forces are directly supported in the gearbox by the bearing 92.

A first cover 110 is fixed to the central plate 90 on the side oriented towards the gearbox, its part being the most distant from the plate includes an edge 115 centring and axially maintaining an annular lever 114. Openings 112 allowing the outlet of the air coming from the channels 96 are located between the central plate 90 and this edge 115. The pressure plate 116 placed in the cover 110 is axially guided and driven in rotation by tongues oriented tangentially and not shown here.

A hollow annular actuator 122 surrounds the external primary shaft 4, its piston acts via the bearing 120 on the lever 114 which, while being supported by the edge 115 of the cover 110, presses an area of the pressure plate 116 being radially inside the edge 115 and the linings of the friction disk 118.

The second cover 130 is fixed on the other side of the central plate 90, it provides the guiding and the driving of the second pressure plate 134, a centring of an annular lever 132 as well as an axial supporting of the lever in an area located radially inside the supporting area of the lever on this pressure plate.

It is to be noted that the centring of each annular lever 114, 132, is directly performed by the covers 110, 130, without using additional centring parts, which allows having a low axial size for the system, simplifying the manufacturing and reducing the costs.

The control mechanism of this second clutch includes a hydraulic actuator 150, axially aligned, and placed in a cylindrical housing realised at the end of the internal primary shaft 6. Moreover, this shaft supports driving gear wheels of which the smallest 151 has a higher diameter than the smallest gear wheel 153 of the other primary shaft 4, in order to ease the installation of the actuator.

The piston 152 of the actuator 150 acts via a needle thrust bearing 154 and via a supporting plate 156 on a control rod 158. A pushing disk 160 is on one hand centred on the annular lever 132, and on the other hand centres the end of the control rod 158 oriented towards the engine, it transfers the axial force coming from the piston 152 to the lever 132.

Moreover, the control rod 158 is centred next to the actuator 150 via a sliding bearing 162 fixed inside the internal primary shaft 6. An annular sealing 164 is placed next to this bearing on engine side, this way, all bearings of this control mechanism, centring bearing 162 and thrust bearing 154, are in lubricating oil of the gearbox which is favourable. As a variant, a second sliding bearing fixed inside the primary shaft 6 can centre the control rod 152 on engine side, the pushing disk 160 then not being centred on the annular lever 132.

It is to be noted that, for each end of the control rod 158, there is one single centring which allows a mounting without unnecessary stress that could lead to wears, and an easy manufacturing.

The end of the rod 158 in contact with the supporting plate 156 has a conical shape with a rather low angle, which fits into a corresponding shape of the plate. This cone on one hand helps the mounting of the rod when it is introduced on engine side, and on the other hand allows increasing the driving torque via friction under the effect of an axial load between this rod 158 and the supporting plate 156 to avoid sliding.

The body 170 of the actuator 150 has an overall revolution shape including a central cylindrical part for the sliding of the piston 152, the end oriented towards the engine or front end is strengthened to stiffen it, the rear end located outside the body of the primary shaft 6 is flared and includes a radial flange 172 that is supported by the casing 174 of the gearbox through an annular sealing 176, a radially external cylindrical part 177 provides the centring.

The fastening of the body 170 on the casing 174 via a flange with flared shape has the advantage to even more stiffen this fastening as well as to improve the positioning accuracy of the body, especially its perpendicularity, which allows reducing the backlash between the body and the housing.

Usefully, the body 170 is formed via an impact extrusion process of an aluminium disk that allows getting thin walls with good quality for the friction of the piston 152, as well as for the sealing that is realised via a lip seal fixed on the piston.

A closing disk 178 closes the hydraulic pressure chamber, it includes a centring 180 including, on the radially outer part, a pressure flange on the casing 174 via an annular sealing 182, it periphery is fixed on the casing via crimping. The disk 178 includes, on the radially outer part of the centring 180, a series of evenly distributed axial pads that press on the radial flange 172 of the body 170 in order to guarantee its position and its sealing, the space between these pads forms a radial way for the hydraulic pressure coming from a duct 184 realised in the casing 174.

Moreover, the closing disk 178 includes a central pad performing the centring and the supporting of a spring 186 that provides a pre-load on the piston 152 in order to permanently keep an axial load between the various parts of the control mechanism, from the piston 152 up to the lever 132, and avoid sliding. However, this pre-load of the spring 186, potentially added to a pre-load coming from the annular lever 132, is lower than the load of the driving tongues of the pressure plate 134 that lift this plate when the hydraulic pressure is low or zero in the actuator 150.

The mounting of the actuator 150 is easy, the body 170 with its piston 152, the spring 186, then the closing metal sheet 178 that is crimped, are successively inserted at the rear of the casing 174.

For the mounting of the dual clutch, the central plate 90, equipped with the bearing 92 and the first friction disk 118 held tight via the cover 110, is installed on the external primary shaft 4 of the gearbox. The open ring 94 is mounted to hold the bearing 92 tight, then the cover 130 is fixed on the central plate 90 after installation of the second friction disk 136 on the internal primary shaft 6.

The FIG. 4 represents a mounting variant of the actuator 150. The body 170 includes at its rear end, outside the housing of the primary shaft 6, successively a radial supporting flange 200 on the casing 174, a cylindrical centring part 202 that grips an annular sealing 204, then a crimping area of the body 170 folded towards the axis into a circular groove of the casing. The mounting of the actuator 150 equipped with its components in the casing is done via the front, then the body 170 is crimped. As a variant, the cylindrical centring part 202 could be radially inserted inside a bore of the casing 174.

The FIG. 5 represents a mounting variant of the actuator 150. The rear part of the body 170 located outside the housing of the primary shaft 6, has a flange including a front edge 203 with a radial supporting side 200 providing the perpendicularity of the body 170, and a rear edge 206 realised via a crimping of the body that is preferably in aluminium. These edges circumscribe a radial groove 205 providing a centring after assembly into a bore of the casing 174. A bevel 207 realised on the front part of the casing's bore compresses an O-ring placed in the groove 205 to provide the sealing.

On FIGS. 3, 4 and 5, an axial crossing for oil is possible between the actuator's body 170 and the housing of the internal primary shaft 6, to especially lubricate the bearings 162, 163 located in the primary shafts 4, 6. The FIG. 5 shows an oil supply duct 208 drilled in the casing 174, and opening into a cavity closed by a baffle 209 that is axially and elastically supported by the end of the primary shaft 6.

The small radial size of the actuator 150 is to be noted, thanks to the thin walls of the body 170 fitting with a reduced backlash, around 1 millimetre, into the cylindrical housing of the shaft, this reduced backlash being possible thanks to the fastening of the body 170 that provides a good perpendicularity. The guiding surfaces of the piston 152 are as close as possible to the housing of the primary shaft 6, the fastening of the body being completely shifted outside this shaft, which allows realising a shaft with reduced diameter.

The FIG. 6 shows a piston 152 sliding leak-proof in an axial bore forming the chamber of the actuator 150, directly realised in the internal primary shaft 6 and forming the cylindrical housing. The pressurised hydraulic chamber, supplied by the duct 184, is closed via a supporting washer 210 mounted in the casing 174 with a sealing 211 in between. This washer, held tight by a bearing 213 of the internal primary shaft 6, supports a dynamic leak-proof gasket 212 in contact with an external cylindrical part located at the end of this shaft.

A metal sheet 214 tight in the internal primary shaft 6 closes the inlet of the bore of the actuator's chamber 150, it allows the centring and the supporting of the end of the spring 186. Openings 216 are on a peripheral part of this metal sheet to provide the oil supply of the actuator in an upper point allowing an air purge. The other end of the bore of the primary shaft includes a drill 218 allowing the communication of this bore with the casing of the gearbox in order to allow the air crossing during movements of the piston 152.

A sensor 220 for the displacement of the piston 152 is installed inside the chamber, in the piston, the fastening as well as the outlet of the wires are supported by the casing 174. This sensor supplies the gearbox control unit with information concerning the position of the piston 152, in order to allow an accurate control of the clutch.

The FIG. 6 shows a simplified piston thrust bearing 152 for the supporting of the rod 158, it includes a supporting plate 222 in processed steel and a ball 224 fitting into an obstructed housing of the piston and held in position via a crimping, the friction happens in oil on processed surfaces close to the axis. This simplified thrust bearing can easily be used in the case of the actuator 150 directly realised inside the primary shaft 6 because the rotational speed of the axial thrust bearing of the piston 152 is reduced or zero depending on if the transmission operates with one clutch or the other.

The variant shown in FIG. 6 allows reducing the number of parts as well as the size of the hydraulic actuator 150. In addition, a pre-assembly of the components of the actuator 150 inside the shaft is possible, which simplifies the mounting.

The housing of the primary shaft 6 does not include any fastening system of the guiding cylindrical surface, this surface being directly provided in the shaft. The radial size of the actuator is reduced, which allows arranging gear wheels and a bearing with small diameter on this shaft.

It is to be noted that the installation of a control actuator 150 into the gearbox has an advantage in the case of slight oil leak flow of the actuator, the oil remaining in the casing of the gearbox.

Generally speaking, the hydraulic pressure needed for the actuators can be generated several ways, it can come from a mechanical pump driven by the thermal engine or from an electrical pump, it can use the lubrication oil of the gearbox or a specific oil, the circuit can be open with control solenoid valves or closed with, for each actuator, an issuing hydraulic actuator that controls the displacement of a defined oil volume.

The FIG. 7 shows a control mechanism for an actuator shifted on the side of the gearbox and acting on a lever 250, this actuator can be a hydraulic or electromechanical one,

The actuator 150 includes a piston 152 with a sealing, sliding in a body 170 having an internal cylindrical guiding surface. Via a processed washer 232, the piston 152 presses a needle thrust bearing 154 that transfers the force to the control rod 158 via a supporting plate 234. The end of the spherical rod 156 fits into a corresponding housing provided on the supporting plate 234, in order to provide a ball-and-socket connection allowing to correcting a lack of alignment.

The rear part of the body 170 located outside the housing of the primary shaft 6, has a flange including a radial groove 205 between a front edge 203 and a rear edge 206, for the assembly into a bore of the casing 174 including a bevel 207 to compress an O-ring.

It is to be noted that the external diameter of the piston 152 is higher than the one of the thrust bearing 154, which allows integrating this thrust bearing into the extension of the piston.

The body 170 can be realised in aluminium, the rear edge 206 then being crimped after assembly. It can also be realised in moulded plastic material, an inlet bevel 207 helping the introduction of the rear edge 206 into the bore, this edge then being clamped at the rear of the casing to hold the body into position. The plastic material is all the best appropriate for the body of the actuator 170 since this component does not contain any pressurised oil, it only forms a guiding surface with a sealing for the piston, the gearbox oil being more or less at the atmospheric pressure.

Usefully, the piston 152 is realised in moulded plastic material, the sealing can then directly be moulded from a casting, which represents a cost-effective process.

The lever 250 includes a drill for the guiding via an axis 254, the ends of this axis are supported by two pads 252 of the casing 174 of the gearbox that flank the lever. The upper part of the lever receives the force F of the actuator via a swiveling connection 260, the lower part transfers the force to a rod 256 via a swiveling connection 258. The other end of this rod has a spherical shape that fits into a corresponding shape 230 of the piston realised at the end of an axial hollow with conical shape, this hollow axially covering a major part of the guiding surface of the piston 152 on the body 170, which allows reducing the size.

The lever 250 can be realised in moulded or forged metal, or in cut or stamped metal sheet. Usefully, the guiding axis 254 and the swiveling connections 258, 260 providing a relatively significant swinging angle, include friction rings to reduce the friction and the control hysteresis which allows improving the control accuracy of the clutch.

Preferably, like for the previous variants, a pre-load spring is planned in order to provide an axial pre-load on the piston 152, this spring can be integrated either into the primary shaft 6, or at the level of the lever 250, or into the external actuator.

Generally speaking, the clutches can work dry or in oil, they can be open or closed at standstill.

A noteworthy advantage of the control mechanism integrated to the internal primary shaft 6 according to the invention is that, as the diameter of the housing in the primary shaft 6 is limited, this control mechanism can all the more cover a relatively significant length without being interfered by the surrounding components and without significantly decreasing the mechanical resistance of the shaft. A relatively long stroke of the piston allows then an easy adaptation to a clutch that does not include an internal device for the wear adjustment of the friction disk that aims the stroke reduction of the control mechanism. The clutch is easier to realise while being more cost-effective.

1. Transmission including a dual clutch transferring the torque of an engine to two input primary shafts of a gearbox, each clutch including at least one friction disk connected in rotation to one of the primary shafts, that can be tightened between plates of which one is axially mobile thanks to a control mechanism, one of these control mechanisms including a piston guided by a cylindrical surface integrated into an axial housing of a primary shaft, characterised in that the guiding cylindrical surface is located as close as possible to the shaft's housing, this surface being directly made inside the shaft's housing or inside a body inserted into the housing which end is connected to the casing of the gearbox via a fastening shifted outside the housing.

2. Transmission according to claim 1, the guiding surface being realised in a body inserted into the housing, characterised in that the body includes a cylindrical part for the sliding of the piston, and a flared end forming a flange with a higher diameter than the cylindrical part, located outside the housing of the primary shaft for the fixing on the casing.

3. Transmission according to claim 2, characterised in that the flange includes, for the fixing on the casing, a plane radial side providing the perpendicularity, a cylindrical part providing the centring and a supporting side for a leak-proof sealing.

4. Transmission according to claim 2, characterised in that the piston circumscribes a hydraulic pressure chamber, and in that a closing disk closing the pressure chamber is tightly fixed on the casing, this closing disk can be crimped on the casing.

5. Transmission according to claim 2, characterised in that a sealing system between the casing and the primary shaft closes an additional chamber surrounding the body, this chamber being supplied in oil via a duct.

6. Transmission according to claim 2, characterised in that the piston is pushed by a mechanical system, a leak-proof sealing being planned between the piston and the body.

7. Transmission according to claim 6, characterised in that the mechanical pushing system is a rod pushing the end of an axial hollow formed inside the piston, this hollow axially covering a major part of the guiding surface of the piston.

8. Transmission according to claim 6, characterised in that a hinged lever on the casing and transferring a force coming from an actuator, is supported by the mechanical system.

9. Transmission according to claim 2, characterised in that the body is done by impact extrusion process of an aluminium disk, this body can be fixed to the casing by crimping.

10. Transmission according to claim 2, characterised in that the body is done by moulding of a plastic material, this body can be fixed to the casing by clamping.

11. Transmission according to claim 1, the guiding surface being directly realised inside a housing of the shaft, characterised in that the piston slides in a bore formed by this housing and circumscribes a hydraulic pressure chamber.

12. Transmission according to claim 11, characterised in that a dynamic leak-proof gasket provides the sealing of the pressure chamber between the primary shaft and the casing, a supporting part can connect the dynamic leak-proof gasket to the casing.

13. Transmission according to claim 11, characterised in that the bore of the primary shaft includes a closing system for the support of a spring.

14. Transmission according to claim 1, characterised in that the piston is moulded in plastic material.

15. Transmission according to claim 1, characterised in that the clutch controlled by the piston does not include any internal device for the wear adjustment of the friction disks.
